(19) United States
(12) Patent Application Publication
(10) Pub. No.: US 2025/0156128 A1
(43) Pub. Date: May 15, 2025

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: HIROAKI HANAI, Chiba (JP)

(21) Appl. No.: 18/942,107

(22) Filed: Nov. 8, 2024

(30) Foreign Application Priority Data
Nov. 13, 2023 (JP) 2023-192966

(51) Int. Cl. G06F 3/12

(52) U.S. Cl. CPC G06F 3/1253; G06F 3/1205; G06F 3/1285

(57) ABSTRACT

A non-transitory computer-readable storage medium storing an application program which causes a processing apparatus to perform a method, the processing apparatus having printing software, the method includes acquiring capability information about a forming apparatus to which print data is to be output, and displaying a setting screen on which setting values for setting items included in the capability information are changeable, wherein the setting items include setting items relating to compression of print data to be output to the forming apparatus to which the print data is to be output.

### BACKGROUND

### Technical Field

The aspect of the embodiments relates to an information processing apparatus, a control method thereof, and a storage medium.

### Description of the Related Art

General-purpose printer drivers that use an industry-standard protocol, such as Internet Printing Protocol (IPP), have been studied in recent years. General-purpose printer drivers include local printer drivers, which connect directly to printers, and cloud printer drivers, which transmit print data to cloud print services.

General-purpose printer drivers are configured to communicate with printers from a plurality of printer vendors. The use of general-purpose printer drivers enables a user to transmit print data to image forming apparatuses and cloud print services even without installing vendor-specific printer drivers.

Because the above-described general-purpose printer drivers handle print jobs to be printed by printers from various vendors, items and functions of which settings are available as print settings are limited. In this regard, extension of print queues, each of which is associated with a different printer driver, by use of identification information about printers, each of which is associated with a different printer driver, has been studied as in a technique discussed in Japanese Patent Application Laid-Open No. 2021-124791. With this technique, vendor-specific print setting screens and print job editing functions are realized.

As in a technique discussed in Japanese Patent Application Laid-Open No. 2023-49478, a compression function is available as one of the print job editing functions. Print data is compressed by a compression method that is supported by an image forming apparatus, to reduce the size of the print data. This reduces a communication load and consequently reduces a delay of printing start in the image forming apparatus.

In printing using a standard printer driver, the standard printer driver generates intermediate data, performs layout editing, and compresses the data in a Portable Document Format (PDF) or Printer Working Group (PWG)-Raster format by using a compression function of an operating system (OS) of a client terminal. In the technique discussed in Japanese Patent Application Laid-Open No. 2023-49478, intermediate data received from a standard printer driver is compressed using a print setting extension application in addition to the standard printer driver.

In the technique discussed in Japanese Patent Application Laid-Open No. 2023-49478, the compression function of the OS and the compression function of the print setting extension application coexist. Under such an environment, determinations and processing relating to compression are performed by the print setting extension application. Specifically, the print setting extension application performs determination of whether compression of data is to be performed to reduce a delay of printing start while reducing the communication load, based on data to be printed, print settings, and capability information about an image forming processing apparatus. In a case where the print setting extension application determines that compressing of data is to be performed, the data is compressed by a compression method supported by the image forming processing apparatus, and the compressed data is transmitted to the image forming processing apparatus.

Meanwhile, there are sometimes cases in which a user desires to print images with higher quality rather than reducing the time for communication.

### SUMMARY

According to an aspect of the embodiments, a non-transitory computer-readable storage medium storing an application program which causes a processing apparatus to perform a method, the processing apparatus having printing software, the method includes acquiring capability information about a forming apparatus to which print data is to be output, and displaying a setting screen on which setting values for setting items included in the capability information are changeable, wherein the setting items include setting items relating to compression of print data to be output to the forming apparatus to which the print data is to be output.

Further features of the disclosure will become apparent from the following description of exemplary embodiments with reference to the attached drawings.

### BRIEF DESCRIPTION OF THE DRAWINGS

FIG. 1 is a block diagram illustrating a configuration example of a printing system according to a first exemplary embodiment of the disclosure.

FIGS. 2A to 2E are block diagrams each illustrating a hardware configuration example of the printing system according to the first exemplary embodiment.

FIGS. 3A and 3B are a sequence diagram illustrating an example of processing from installation of a print setting extension application to printing according to the first exemplary embodiment.

FIG. 4 illustrates an example of a screen that is displayed on a client terminal according to the first exemplary embodiment.

FIG. 5 illustrates an example of information contained in device capability information according to the first exemplary embodiment.

FIG. 6 illustrates an example of device capability information included in an operating system (OS) according to the first exemplary embodiment.

FIGS. 7A and 7B illustrate an example of extended device capability information according to the first exemplary embodiment.

FIGS. 8A to 8C are a sequence diagram illustrating an example of processing up to printing that is performed between each software and a print service according to the first exemplary embodiment.

FIG. 9 illustrates an example of a print setting initial screen on which a print queue is selected according to the first exemplary embodiment.

FIGS. 10A and 10B each illustrate an example of a print setting screen that is displayed in a case where the print setting extension application according to the first exemplary embodiment is installed.

FIGS. 11A and 11B illustrate an example of a general-purpose print setting screen that is displayed by the OS according to the first exemplary embodiment.

FIG. 12 is a flowchart illustrating compression processing that is performed by the print setting extension application according to the first exemplary embodiment.

FIG. 13 is a sequence diagram illustrating an example of processing that is performed to change a print setting from a remote user interface (UI) according to a second exemplary embodiment.

FIG. 14 illustrates an example of a print setting screen on the remote UI according to the second exemplary embodiment.

### DESCRIPTION OF THE EMBODIMENTS

Hereinafter, exemplary embodiments for carrying out the present disclosure will be described with reference to the drawings.

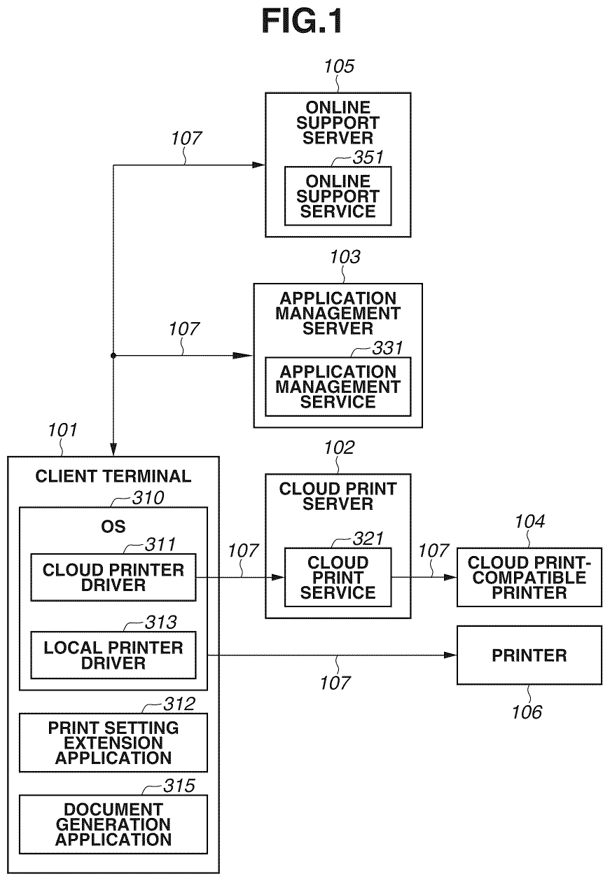

A first exemplary embodiment of the disclosure will be described. FIG. 1 is a block diagram illustrating a configuration example of a printing system according to the present exemplary embodiment. A client terminal 101, a cloud print server 102, an application management server 103, a cloud print-compatible printer 104, an online support server 105, and a printer 106 are interconnected via a network 107.

While FIG. 1 illustrates a configuration example where one client terminal 101 and one cloud print-compatible printer 104 are used, a plurality of client terminals 101 and a plurality of cloud print-compatible printers 104 may be used.

Each of the cloud print server 102, the application management server 103, and the online support server 105 may be configured as a server system including a plurality of information processing apparatuses. In a configuration in which each of the cloud print server 102, the application management server 103, and the online support server 105 is configured as a server system including a plurality of information processing apparatuses, a load is able to be distributed to the plurality of information processing apparatuses.

The cloud print server 102, the application management server 103, and the online support server 105 may be virtually configured in one physical information processing apparatus.

The present exemplary embodiment is described using a case in which a wide area network (WAN) such as the Internet is used as the network 107 to connect to a cloud service, a closed environment such as a local area network (LAN) in a company may be used as the network 107.

The client terminal 101 is an information processing apparatus, such as a personal computer (PC), a tablet, or a smartphone, and is a terminal that is operated by a user. Any application software is executable on the client terminal 101.

An operating system (OS) 310 of the client terminal 101 functions as software to generate print data that is printable using printers provided by a plurality of vendors.

The cloud print-compatible printer 104 and the printer 106 are devices that actually perform printing on a recording medium, such as a sheet, and are image forming apparatuses that convert print data received via the network 107 into image data and perform printing based on the image data. The cloud print-compatible printer 104 and the printer 106 may have the same hardware configuration. The cloud print-compatible printer 104 and the printer 106 are examples of an image forming apparatus to which print data is to be output.

The printer 106 is connected to be able to communicate with the client terminal 101 without involving a cloud print service 321. Print data to be transmitted to the printer 106 is generated by a local printer driver 313.

The cloud print-compatible printer 104 is connected to be able to communicate with the client terminal 101 via the cloud print service 321 provided by the cloud print server 102. Print data to be transmitted to the cloud print-compatible printer 104 is generated by a cloud printer driver 311.

Print data generated by the local printer driver 313 may be received by the cloud print-compatible printer 104 without involving the cloud print service 321, and the cloud print-compatible printer 104 may perform printing based on the received print data. The printer 106 may receive print data generated by the cloud printer driver 311 via the cloud print service 321.

In this case, the cloud printer driver 311 and the local printer driver 313 are standard printer drivers that are preliminarily installed on the OS 310 and are configured to communicate with printers manufactured by a plurality of printer vendors and to perform printing.

A print setting extension application 312 is an application that is supported by printers provided by printer vendors and is used to extend functions provided by the OS 310. The print setting extension application 312 is also referred to as a print support application (PSA). The use of the print setting extension application 312 enables the user to use print functions (including a post-processing function such as stapling) that cannot be used only with the standard printer driver even though the print functions are supported by the printer.

A document generation application 315 is software for creating contents (documents, images, etc.) to be printed. For example, the document generation application 315 corresponds to a document creation application, a spreadsheet application, a drawing application, and the like. In response to receipt of a print request from the user, the document generation application 315 issues a print instruction to the OS 310.

The cloud print server 102 receives the print instruction and print data from an external device. The cloud print server 102 transmits the received print data to the predetermined cloud print-compatible printer 104.

The application management server 103 holds and manages various applications.

The application management server 103 receives application identification information and a download request from the client terminal 101, and transmits an application identified based on the received identification information to the client terminal 101.

The online support server 105 is a server device for providing an online support service 351. The online support service 351 is a server device for providing the client terminal 101 with a file in which information for extending functions of the client terminal 101 is described.

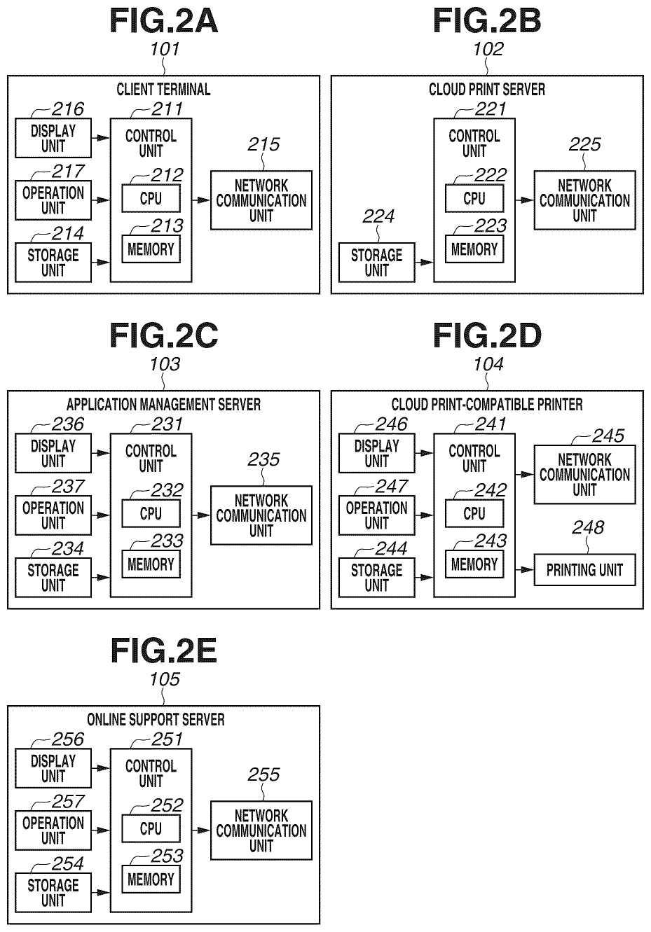

A hardware configuration example of the printing system according to the present exemplary embodiment will be described with reference to FIGS. 2A to 2E.

FIG. 2A is a block diagram illustrating a hardware configuration example of the client terminal 101.

The client terminal 101 includes a display unit 216, an operation unit 217, a storage unit 214, a control unit 211, and a network communication unit 215.

The storage unit 214 indicates a nonvolatile storage device, such as a hard disk or a solid-state drive (SSD), and is configured to store and rewrite digital data.

The control unit 211 is a computer that includes a central processing unit (CPU) 212 and a memory 213 and controls the overall operation of the client terminal 101. The CPU 212 loads programs stored in the storage unit 214 into the memory 213 and executes the programs. The memory 213 is a main storage memory for the CPU 212 and is used as a work area or a temporary storage area for loading various programs.

The network communication unit 215 is a device for communicating with the external network 107, and inputs and outputs digital data to and from an external server, the client terminal 101, or the like via the network 107.

The display unit 216 is a device, such as a liquid crystal display, for displaying visual information for the user in real time. The operation unit 217 is a device for receiving an input from the user via a keyboard, a mouse, or the like. A device, such as a touch panel that includes both functions of the display unit 216 and the operation unit 217 may be used.

FIG. 2B is a block diagram illustrating a hardware configuration example of the cloud print server 102. The cloud print server 102 includes a storage unit 224, a control unit 221, and a network communication unit 225.

The configuration of each of the storage unit 224, the control unit 221, and the network communication unit 225 is similar to the configuration of the corresponding unit of the client terminal 101, and thus the redundant descriptions are omitted.

The cloud print server 102 is includes one information processing apparatus having the hardware configuration illustrated in FIG. 2B, but instead may be composed of a plurality of information processing apparatuses having the configuration illustrated in FIG. 2B.

FIG. 2C is a block diagram illustrating a hardware configuration example of the application management server 103. The application management server 103 includes a display unit 236, an operation unit 237, a storage unit 234, a control unit 231, and a network communication unit 235.

The configuration of each of the display unit 236, the operation unit 237, the storage unit 234, the control unit 231, and the network communication unit 235 is similar to the configuration of the corresponding unit of the client terminal 101, and thus the redundant descriptions are omitted.

The application management server 103 includes one information processing apparatus having the hardware configuration illustrated in FIG. 2C, but instead may be composed of a plurality of information processing apparatuses.

FIG. 2D is a block diagram illustrating a hardware configuration example of the cloud print-compatible printer 104. The cloud print-compatible printer 104 includes a display unit 246, an operation unit 247, a storage unit 244, a control unit 241, a network communication unit 245, and a printing unit 248.

The display unit 246 is a device for displaying information for the user in real time. The display unit 246 is, for example, a touch panel or a light-emitting diode (LED) attached to the cloud print-compatible printer 104.

The operation unit 247 is a device for receiving an input from the user, and may include not only a touch panel, but also hardware keys such as a numeric keypad. The configuration of each of the storage unit 244 and the control unit 241 is similar to the configuration of the corresponding unit of the client terminal 101, and thus the redundant descriptions are omitted.

The network communication unit 245 is a device for communicating with the external network 107, and functions to mainly receive print data and transmit the state of the cloud print-compatible printer 104, such as an error state, to the external server or the like.

The printing unit 248 is a device for performing a series of operations, including sheet feeding, printing, and sheet discharge, on sheets prepared on a cassette or a tray, whereby print processing is performed. A printing method to be used is not particularly limited. For example, an electrophotographic method or an inkjet method can be used. The printing unit 248 includes finishing devices, such as a double-sided unit, a stapling unit, and a punching unit, which are used during a sheet discharge operation.

While the present exemplary embodiment illustrates a single-function printer including the print function as an example of the cloud print-compatible printer 104, a multi-function printer (multi-function peripheral) including a scanner function and a facsimile (FAX) function in addition to the print function, can also be used. The hardware configuration of the printer 106 illustrated in FIG. 1 is also similar to the hardware configuration illustrated in FIG. 2D.

FIG. 2E is a block diagram illustrating a detailed hardware configuration of the online support server 105. In the present exemplary embodiment, the online support server 105 includes one information processing apparatus, but instead may be composed of a plurality of information processing apparatuses. The online support server includes a display unit 256, an operation unit 257, a storage unit 254, a control unit 251, and a network communication unit 255.

The display unit 256 and the operation unit 257 are similar to the display unit 216 and the operation unit 217 of the client terminal 101, respectively, and thus the redundant descriptions are omitted. The storage unit 254 is a memory device, such as a hard disk drive (HDD) or an SSD. The storage unit 254 stores a file in which information for extending functions provided by the client terminal 101 is described.

The control unit 251 is composed of a CPU 252 and a memory 253. The CPU 252 controls the overall operation of the online support server 105. The memory 253 is used for processing that is executed by the CPU 252. The network communication unit 255 is an interface for the online support server 105 to communicate with the client terminal 101. The online support server 105 receives a request for acquisition of a file stored in the storage unit 254 via the network communication unit 255, and transmits the corresponding file to the client terminal 101.

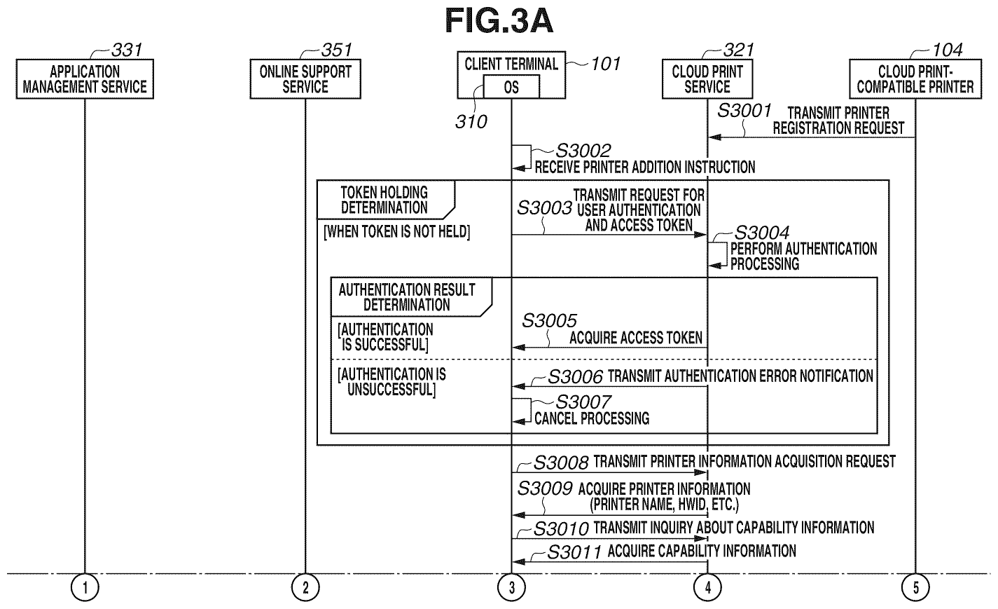

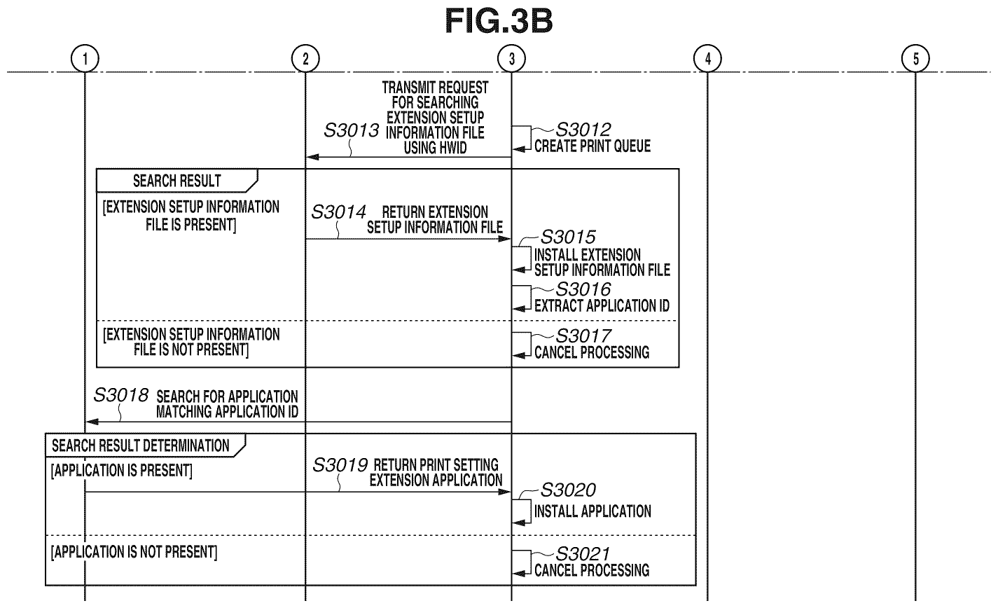

An example of a processing procedure for the user and an example of a sequence between each software and a print service according to the present exemplary embodiment will be described with reference to FIGS. 3A and 3B.

First, the cloud print-compatible printer 104 receives, from the user, an operation for registration of the cloud print-compatible printer 104 in the cloud print service 321. In step S3001, the cloud print-compatible printer 104 transmits device identification information about the printer and a printer registration request to the cloud print service 321 according to the registration operation. Any information can be used as the device identification information, as long as the information can be used to identify the type of each printer. The device identification information is, for example, a hardware identification (HWID) that is assigned to each type of printers.

In response to receipt of the registration request, the cloud print service 321 transmits a uniform resource locator (URL) of the cloud print service 321 for printer registration to the cloud print-compatible printer 104.

The user accesses the URL from the cloud print-compatible printer 104 or the information processing apparatus, inputs a user ID and a password to use the cloud print service 321, and logs into the cloud print service 321.

When the user has successfully logged in, the cloud print service 321 transmits a request to acquire information to be used for printer registration to the cloud print-compatible printer 104. The cloud print-compatible printer 104 transmits the printer information to the cloud print service 321 in response to the request.

Next, the cloud print service 321 registers information about the cloud print-compatible printer 104 and creates a print queue for the cloud print-compatible printer 104. In this processing, the cloud print service 321 acquires capability information about the cloud print-compatible printer 104 and associates the acquired capability information with the created print queue.

The capability information is information indicating functions included in the printer. The capability information indicates information to be used by the user as print settings during printing, such as image forming functions, including double-sided printing information and color printing information, and post-processing functions, including information indicating whether stapling is supported.

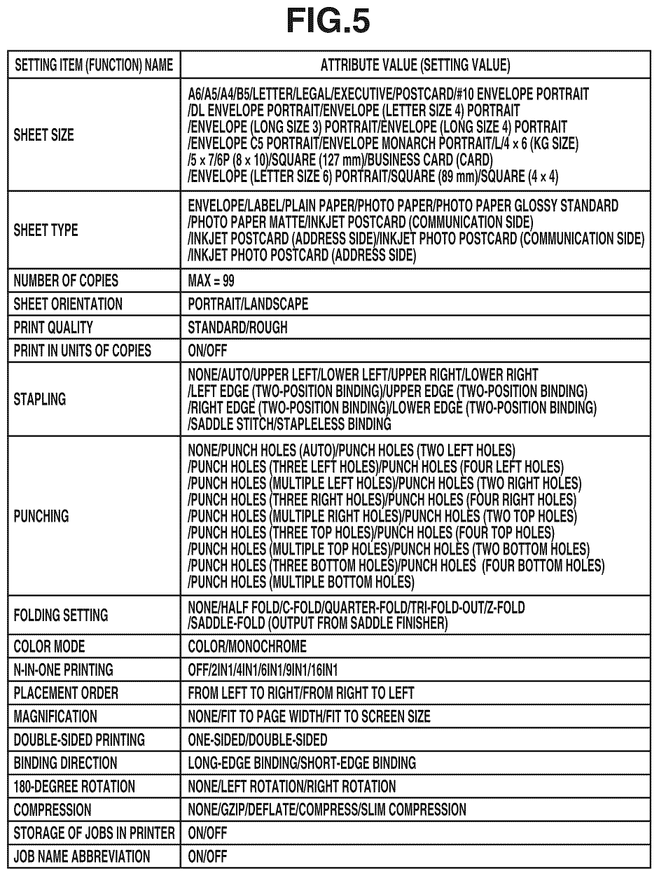

Specifically, a description is given of a case in which an Internet Print Protocol (IPP) is used as a communication protocol. The cloud print-compatible printer 104 transmits an example of capability information containing an item name and an attribute value as illustrated in FIG. 5 to the cloud print service 321. Even in a case where an attribute designated in an inquiry from the cloud print service 321 is not defined in the IPP, the cloud print-compatible printer 104 directly transmits a notification about the attribute to the cloud print service 321.

Installation processing for the cloud printer driver 311 and the print setting extension application 312 in a case where the user performs a setup operation for printing using the cloud print-compatible printer 104 on the client terminal 101 will be described.

The OS 310 of the client terminal 101 receives a setup operation for the cloud print-compatible printer 104 from the user. The setup operation for the cloud print-compatible printer 104 is, for example, the following operation.

In step S3002, the OS 310 of the client terminal 101 receives a printer addition instruction from the user.

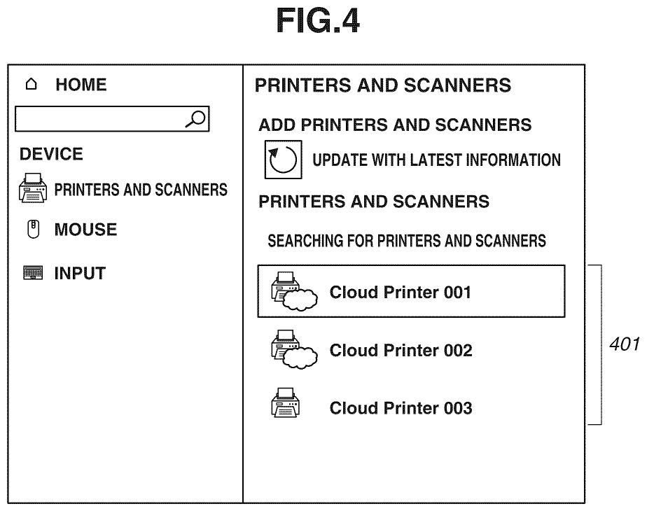

FIG. 4 illustrates an example of a screen that is displayed by the OS 310 of the client terminal 101 to manage information about print queues registered in the OS 310. The user selects a button from a list 401 of buttons to input the printer addition instruction to the OS 310.

The OS 310 that has received the printer addition instruction determines whether a token for acquisition of information from the cloud print service 321 is held.

In a case where the token is not held, the OS 310 displays a screen for inputting user information, i.e., login name and password. In step S3003, the OS 310 transmits the user information input via the screen to the cloud print service 321, performs user authentication, and transmits a request for an access token.

In step S3004, the cloud print service 321 performs authentication processing using the user information received from the client terminal 101. After completion of the authentication processing, the cloud print service 321 transmits a notification about a result of the authentication processing to the client terminal 101.

In a case where the user authentication is successful, in step S3005, the OS 310 acquires the access token from the cloud print service 321.

In a case where the user authentication is unsuccessful, in step S3006, the cloud print service 321 transmits an authentication error notification to the OS 310 of the client terminal 101.

In step S3007, the OS 310 of the client terminal 101 cancels the processing based on the received authentication error information. The OS 310 terminates the processing illustrated in FIGS. 3A and 3B.

In a case where the client terminal 101 has already held the access token, or in a case where the token is acquired in step S3005, the processing proceeds to step S3008, and the OS 310 of the client terminal 101 performs processing. In step S3008, the OS 310 searches for printers registered in the cloud print service 321 and printers connected to the network 107. In step S3008, the OS 310 attaches the access token to a request for acquiring information about printers registered in the cloud print service 321, and transmits the printer information acquisition request.

The cloud print service 321 identifies a tenant ID for a tenant to which the user identified by the access token attached to the acquisition request belongs, and generates a list of printers associated with the tenant ID for the tenant to which the user belongs.

In step S3009, the OS 310 of the client terminal 101 acquires printer information containing the printer list generated by the cloud print service 321 and each identification information.

The OS 310 displays the printer list on the client terminal 101 based on the printer information acquired from the cloud print service 321 and the printer information detected in the search on the network 107. The list 401 illustrated in FIG. 4 are a list of buttons indicating printers searched in the printer information received from the cloud print service 321 and printers searched on the local network.

The user selects printer information about the printer to be registered in the client terminal 101 from among the printers displayed on the list 401. In step S3010, the OS 310 transmits an inquiry about capability information about the cloud print-compatible printer 104 selected for the cloud print service 321. Which attribute is designated in the inquiry is determined by the OS 310 that transmits the inquiry, like in the above-described structure.

In step S3011, the cloud print service 321 returns the capability information about the cloud print-compatible printer 104 as a response to the OS 310. The capability information about the cloud print-compatible printer 104 may be capability information acquired during printer registration, or may be the latest capability information acquired from the cloud print-compatible printer 104 during the inquiry from the OS 310.

In a case where a response to the attribute designated in the inquiry from the OS 310 of the client terminal 101 is not stored, the cloud print service 321 sends no response to the OS 310.

The OS 310 starts to install the cloud printer driver 311, based on the device identification information about the printer selected by the user and the printer name.

In step S3012, the OS 310 creates a print queue for the cloud printer driver 311 including basic device capability information included in the OS 310. The device capability information indicates definition information for generation of print setting capability information for a printer driver, for example, information described in an extensible markup language (XML) such as Print Device Capabilities (PDC). The print setting capability information (e.g., Print Capabilities (PC)) is information that is used to display a print setting screen, and is generated based on the device capability information.

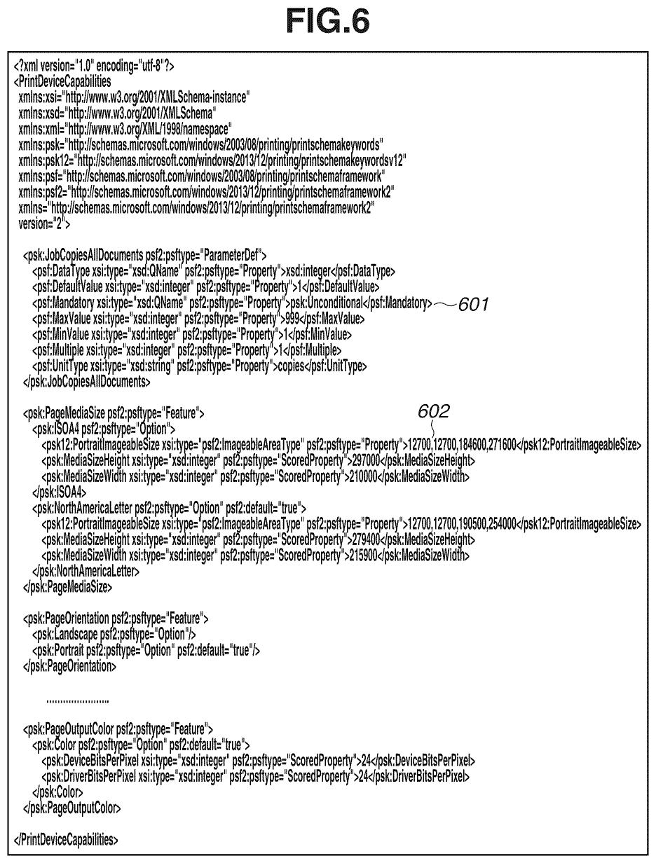

FIG. 6 illustrates an example of device capability information included in the OS 310. Information 601 illustrated in FIG. 6 indicates information about the number of copies. This information indicates that the minimum number of copies is one, and the maximum number of copies is 999.

Information 602 indicates information about a sheet size. “Feature” indicates a function name, and “Option” indicates information about setting values that are selectable in the function. The information 602 indicates that the selectable setting values in the sheet size function are two which are “A4” and “Letter”. The device capability information is associated with a print queue and is managed by the OS 310.

After that, based on the capability information acquired from the cloud print service 321, the OS 310 updates the device capability information included in the cloud printer driver 311.

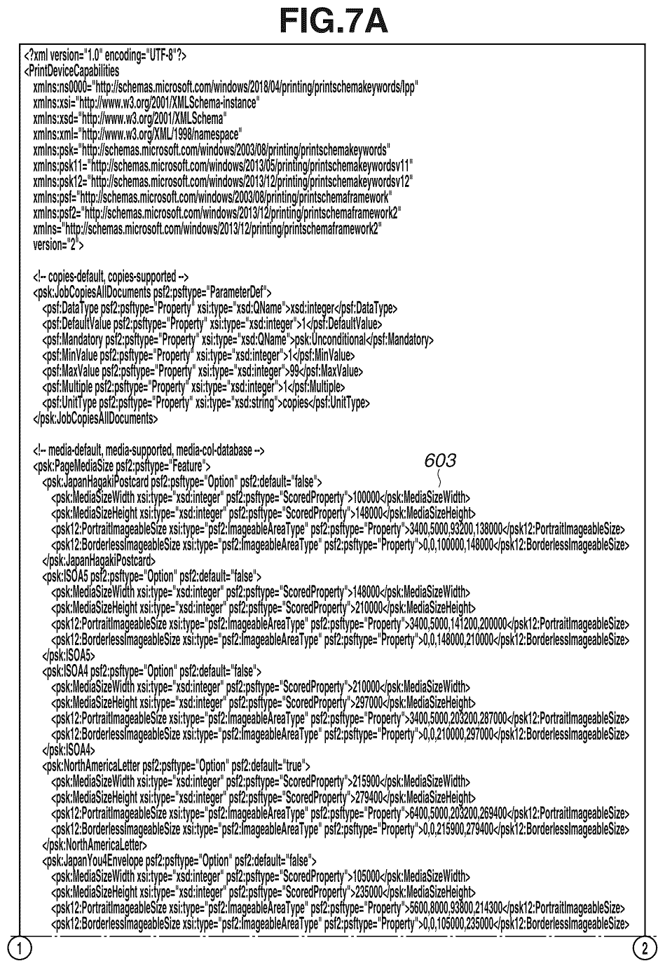

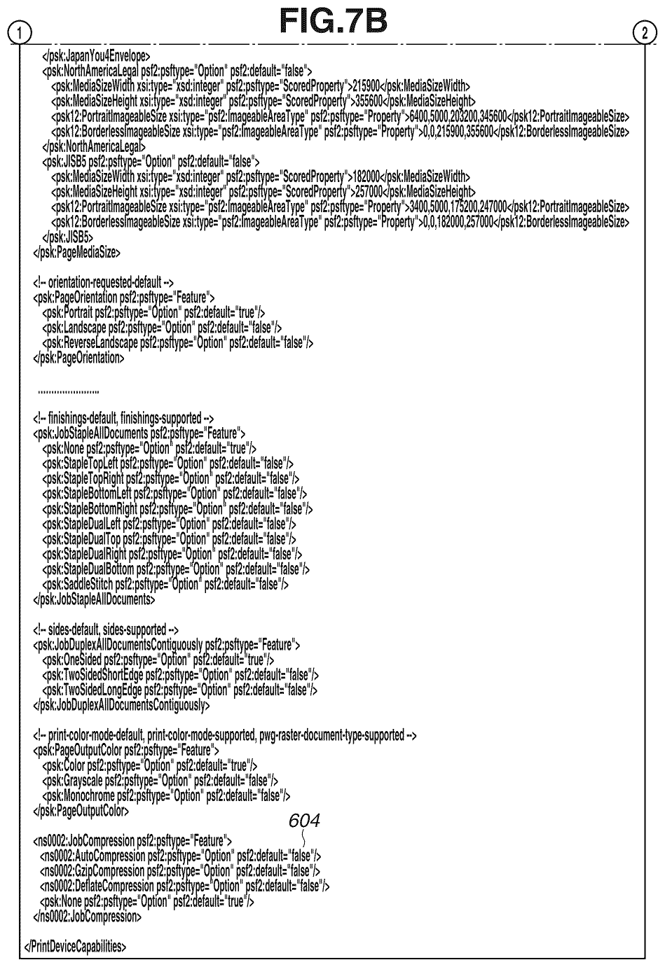

FIGS. 7A and 7B illustrate an example of device capability information updated with the capability information acquired from the cloud print service 321. Information 603 indicates an updated sheet size. A setting value (Option) other than “A4” and “Letter” is added as a sheet size that is printable by the cloud print-compatible printer 104 to the function (Feature, setting item) “PageMediaSize”.

Information 604 indicates an added compression function. As described above, a new function (Feature) and a setting value (Option) for the function is able to be added.

The OS 310 registers the HWID of the printer, device capability information about the printer, and identification information about the printer driver to be used in association with the print queue.

By the above-describe operation, the installation processing for the cloud printer driver 311 is completed.

Next, the OS 310 starts installation processing for the print setting extension application 312 to extend a cloud print driver in association with the printer.

The OS 310 performs processing to assign identification additional information to the device identification information. This processing is performed to acquire an extension setup information file for the online support server 105, and identification information after adding the identification additional information may be a character string different from general device identification information.

In the present exemplary embodiment, the OS 310 assigns identification additional information (“PrinterApp_”) indicating the application corresponding to the printer to distinguish the application from another device application. The identification additional information “PrinterApp_” is merely an example. Any other character strings, numbers, or symbols may be used.

As a result, for example, in a case where the device identification information about the cloud print-compatible printer 104 is “device001”, device identification information obtained after the identification additional information assignment processing is “PrinterApp_device001”.

In step S3013, the OS 310 transmits a request for searching for the extension setup information file to the online support service 351. The OS 310 transmits device identification information to which the identification additional information has been added, to the online support service 351.

As a result of search, in a case where the online support service 351 holds the extension setup information file including the target device identification information, in step S3014, the online support service 351 returns the extension setup information file to the OS 310.

In step S3015, the OS 310 acquires the extension setup information file from the online support service 351 and installs extension setup information. The OS 310 reads out the contents of the extension setup information and records the read contents on a registry. In step S3016, the OS 310 extracts an application ID from the installed extension setup information.

As a result of search, the online support service 351 may not hold the extension setup information file including the target device identification information. In this case, in step S3017, the OS 310 cancels the application installation processing, while the installation of the cloud print driver is completed.

In step S3018, the OS 310 transmits a request for acquiring an application matching the application ID extracted from the extension setup information file to an application management service 331.

In a case where the application management service 331 holds the requested print setting extension application corresponding to the application ID, in step S3019, the application management service 331 returns the print setting extension application 312.

In step S3020, the OS 310 installs the print setting extension application 312 and associates the print setting extension application 312 with the print queue on the client side. Specifically, the application ID is stored as information about the print queue in the registry of the OS 310, and in response to calling of the created print queue, the OS 310 starts the print setting extension application 312 installed in this process by using the information.

The application management service 331 may not hold the requested print setting extension application corresponding to the application ID. In this case, in step S3021, the OS 310 completes the installation of the cloud print driver and cancels the application installation processing.

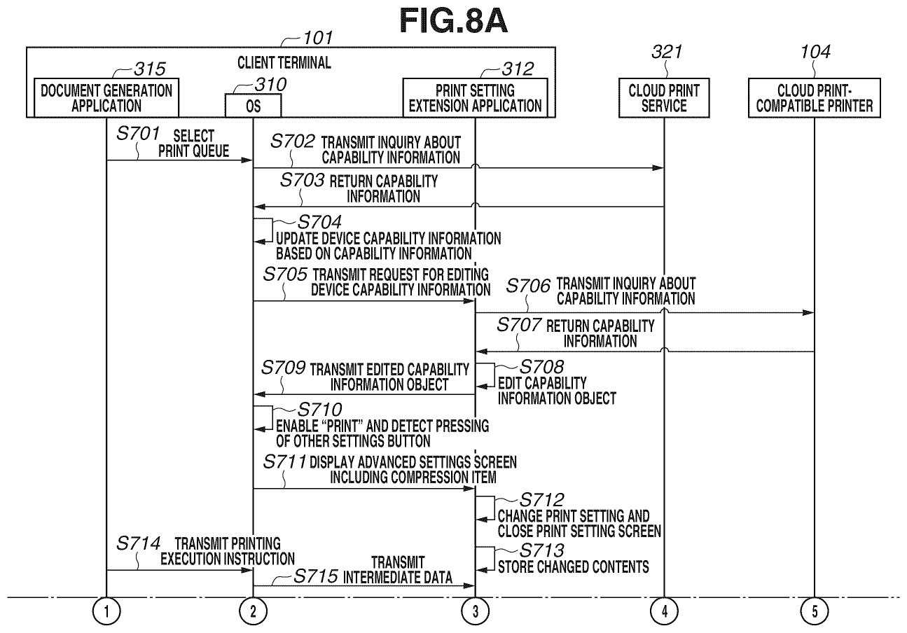

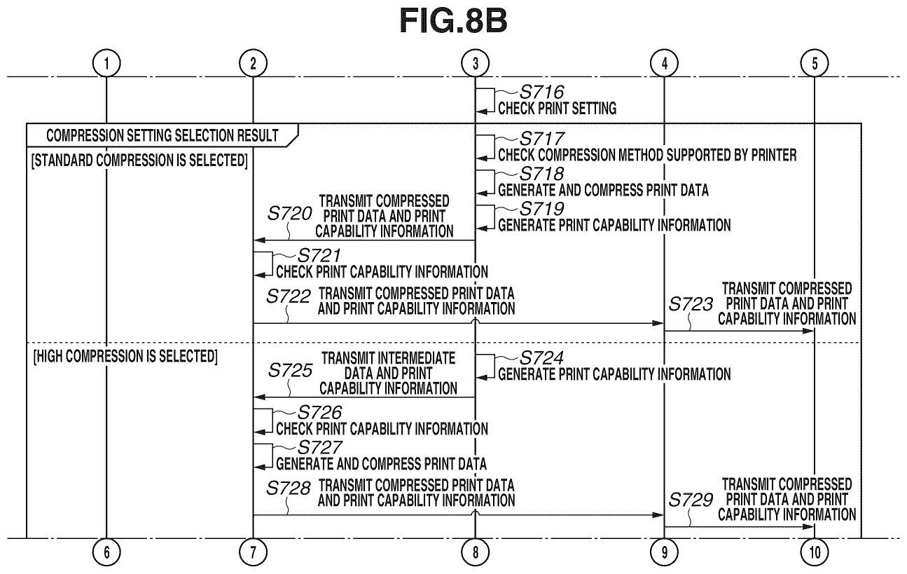

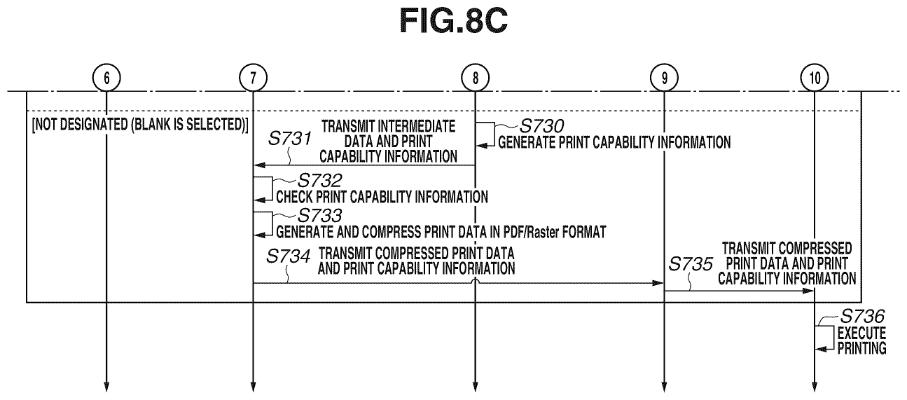

Next, an example of a sequence of processing up to printing between each software and a print service according to the present exemplary embodiment will be described with reference to FIGS. 8A to 8C.

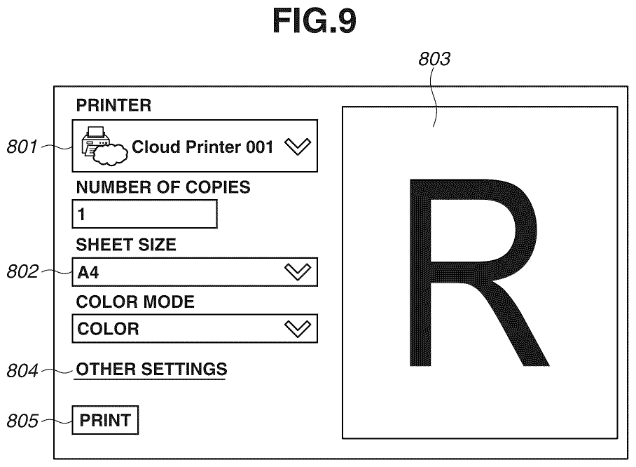

The document generation application 315 requests the OS 310 to display a print setting screen illustrated in FIG. 9. The OS 310 displays the print setting screen to select a print queue. In the present exemplary embodiment, the OS 310 displays the print setting screen to select a print queue as an initial screen, but instead the document generation application 315 may display the print setting screen. On the print setting screen, not only a user interface (UI) 801 for selecting a print queue, but also various print settings UIs 802, a print preview 803, other settings button 804, and a print button 805 may be displayed.

In step S701, the OS 310 receives a selection result on the UI 801 for a selection of a print queue from the user, and selects a print queue.

In step S702, the OS 310 transmits an inquiry about the capability information about the cloud print-compatible printer 104 for the print queue corresponding to the cloud print-compatible printer 104 on the cloud print service 321. The capability information designated in the inquiry is determined by the OS 310, and is similar to the capability information described in step S3010 illustrated in FIG. 3A. As a method for transmitting an inquiry, for example, an IPP standard protocol, such as Get-printer-Attributes may be used. In the case of using Get-printer-Attributes, an inquiry about capability information determined by the OS 310 is transmitted in a list format.

In step S703, the cloud print service 321 returns the capability information about the cloud print-compatible printer 104 as a response to the OS 310 using the same protocol.

For example, in a case where a media size attribute is designated using Get-printer-Attributes, and in case where the cloud print service 321 holds a media size attribute, a value (A4, B6, Letter, etc.) associated with the attribute is returned.

In response to a compression attribute being designated using Get-printer-Attributes, the cloud print service 321 returns a value (gzip, deflate, compress, none, etc.) for a compression method supported by the cloud print-compatible printer 104.

The compression method supported by the cloud print-compatible printer 104 may be a compression method for decompressing (expanding) compressed data by the cloud print-compatible printer 104.

The cloud print service 321 does not return any value as a response in a case where the attribute designated using Get-printer-Attributes is not present in the print queue for the cloud print-compatible printer 104 on the cloud print service 321.

In step S704, based on the capability information acquired from the cloud print service 321, the OS 310 updates the device capability information. In the case of updating the device capability information, for example, capability information acquired for the device capability information generated in step S3012 illustrated in FIG. 3B is added.

In step S705, the OS 310 transmits a notification about an event for editing of device capability information to the print setting extension application 312. After the receiving of this event, the print setting extension application 312 can use an application programming interface (API) capable of editing device capability information. This enables the print setting extension application 312 to retrieve capability information that is not supported by the OS 310, from the cloud print service 321.

After the receiving of the device capability information editing event, in step S706, the print setting extension application 312 transmits an inquiry about the capability information about the cloud print-compatible printer 104 via the cloud print service 321. In this case, the print setting extension application 312 transmits an inquiry about specific capability information separately from the capability information designated in the inquiry from the OS 310.

The specific capability information corresponds to, for example, vendor-specific settings, such as “stapleless binding” and “saddle-fold” in the settings illustrated in FIG. 5. The specific capability information for compression corresponds to, for example, “slim compression” for a host to compress a print image on which image processing including dithering processing has been performed, so that even a printer with low processing capability is also able to print the print image.

As a method for transmitting an inquiry, Get-printer-Attributes is usable to transmit an inquiry in which “stapleless binding” or “saddle-fold” is designated, like in step S702 illustrated in FIG. 8A.

While the present exemplary embodiment illustrates an example where a setting value for an existing function (e.g., addition of a setting value “stapleless binding” for the “stapling” function) is added, a new function may also be added. Even in the case of adding a new function, information about the function is available from the cloud print-compatible printer 104, as long as the function is supported by the cloud print-compatible printer 104.

In response to an inquiry about specific capability information being transmitted from the print setting extension application 312, in step S707, the cloud print-compatible printer 104 returns the capability information as a response to the print setting extension application 312 via the cloud print service 321. As a method for transmitting a response in this case, a method similar to that used in step S703 illustrated in FIG. 8A described above may be used.

In a case where the capability information about the cloud print-compatible printer 104 is registered in the cloud print service 321, the processing of steps S706 and S707 may be performed between the print setting extension application 312 and the cloud print service 321.

For example, in a case where the function (Feature), such as compression, is supported by the OS 310 and a setting value (Option) for “slim compression” is added, the setting value may be added in the processing of steps S702 and S703. Specifically, the function “slim compression” may be registered below the Feature “compression”, like other setting values, such as gzip, without independently setting the function as a specific function, whereby the function “slim compression” is included in the capability information to be returned in step S703. In this case, the function “slim compression” is also included in the capability information obtained in step S3011 illustrated in FIG. 3A.

After the acquiring of the specific capability information from the cloud print-compatible printer 104, the print setting extension application 312 edits the device capability information via a capability information object. The capability information object is a set of data to be used by the print setting extension application 312 in editing of the device capability information.

The print setting extension application 312 cannot directly edit the device capability information included in the OS 310. This capability information object is used to cause the device capability information included in the OS 310 to be changed. In step S708, the print setting extension application 312 converts the capability information, such as “stapleless binding” or “saddle-fold”, which is acquired in step S707 illustrated in FIGS. 8A to 8C into device capability information, and adds the device capability information to the capability information object.

In step S709, the print setting extension application 312 transmits the edited capability information object to the OS 310. In response to receipt of the capability information object from the print setting extension application 312, the OS 310 reflects the contents of the capability information object in the device capability information included in the OS 310, and updates the contents as new device capability information.

The processing illustrated in FIGS. 8A to 8C is started in response to the document generation application 315 starting printing as in step S701, and steps S702 to S708 are processing for acquiring the latest capability information about the cloud print-compatible printer 104. Thus, information other than an instruction from the user and a predetermined timing (every Monday etc.) may be omitted.

In response to the OS 310 updating the device capability information, a trigger for starting an advanced settings screen for the print setting extension application 312 is enabled. In step S710, in response to the OS 310 detecting pressing of the other settings button 804 by the user, the OS 310 transmits a request for the print setting extension application 312 to display the advanced settings screen.

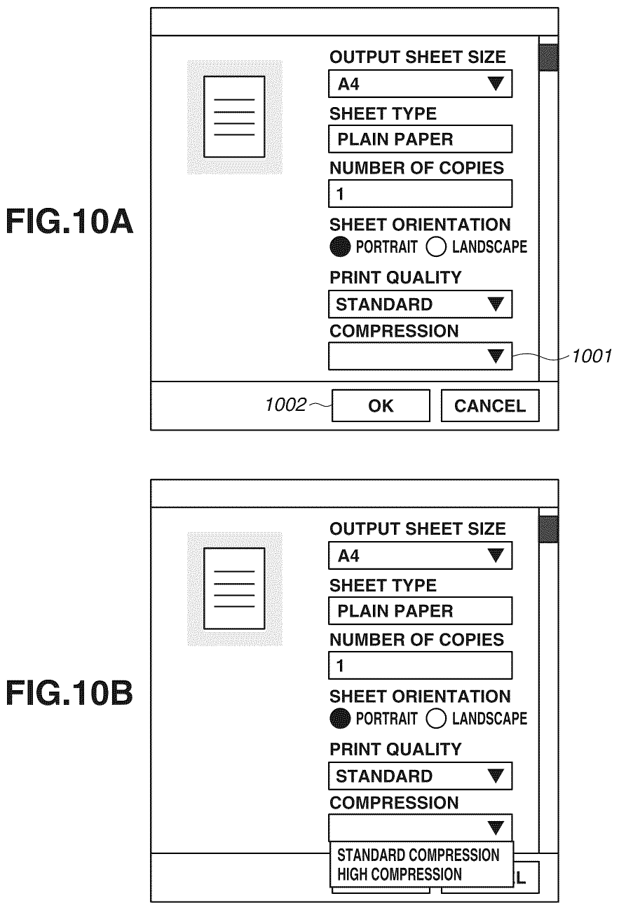

In response to receipt of the request from the OS 310, in step S711, the print setting extension application 312 generates and displays a print setting screen as illustrated in FIG. 10A based on the print setting capability information generated by the OS 310 based on the device capability information.

For example, the print setting extension application 312 displays print setting capability information generated based on “psk:PageMediaSize” illustrated in FIGS. 7A and 7B as an output sheet size in the setting items illustrated in FIG. 10A. The print setting extension application 312 generates an option (setting value) “A4” for the output sheet size based on information “psk:ISOA4” and displays the generated option.

Similarly, the print setting extension application 312 displays print setting capability information generated based on information “ns0002:JobCompression” illustrated in FIGS. 67A and 7B for compression in the setting items illustrated in FIG. 10A. A compression item 1001 is generated in a case where a general-purpose compression method and a vendor-specific compression method has been acquired.

In an example illustrated in FIG. 10B, a blank for not designating any compression method, “standard compression” for compression that is performed by the OS 310, and “high compression” for compression that is performed by the print setting extension application 312 using a vendor-specific compression method are displayed as options. For example, in a case where the vendor-specific compression method is not supported by the printer, “high compression” may be hidden or grayed out so as to prevent the user from selecting this item.

Specific compression methods such as “slim compression” and “gzip” may be set as options to be displayed. For example, a blank, “slim compression”, and “standard compression” may be set as options to be displayed. A method for classifying the items “high compression” and “standard compression” is not limited to the above-described method. These items may be classified based on the magnitude of a difference between a data size before compression and a data size after compression.

In this case, for example, there may be the following cases. That is, the acquired compression method is not supported by the print setting extension application 312, the compression support state of the printer indicates “unsupported”, or the item corresponding to the compression method is blank or none and the printer does not support compression. In such cases, the options may be hidden or grayed out to prevent the user from selecting the options.

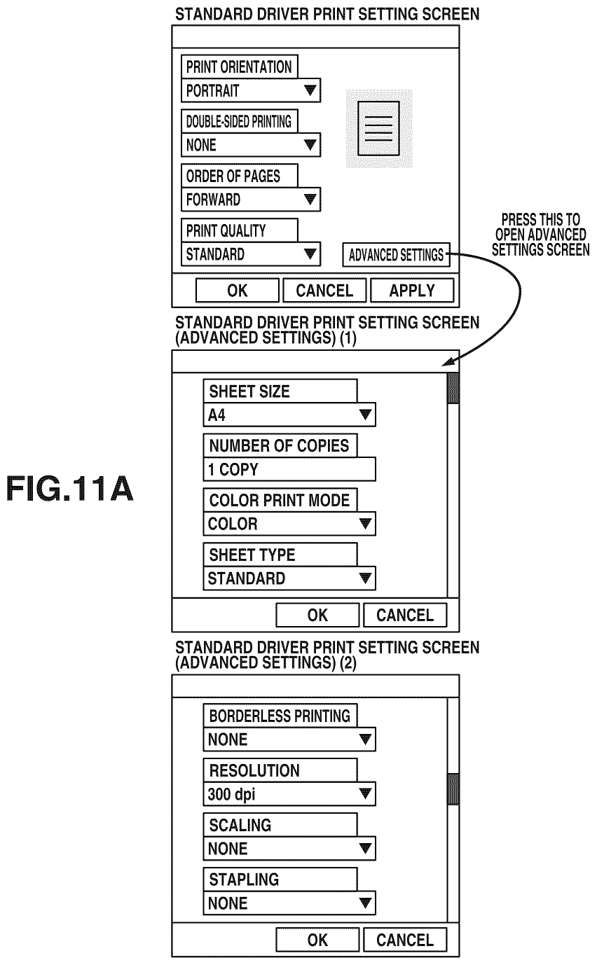

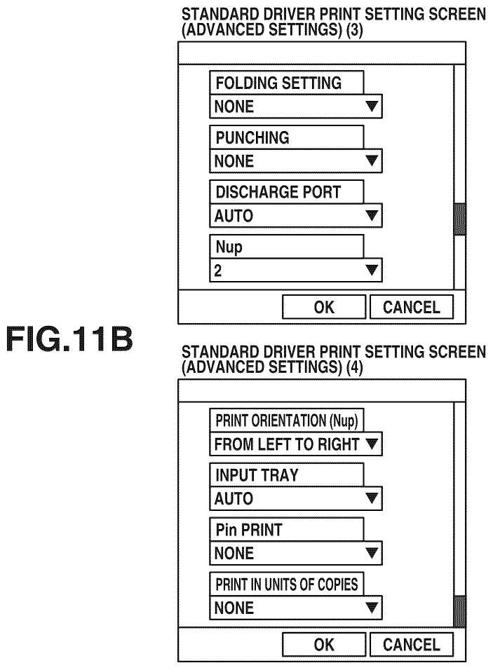

In a case where the print setting extension application 312 is not associated with the cloud printer driver 311, the print setting screen for the standard printer driver preliminarily installed on the OS 310 is displayed as illustrated in FIG. 11A. On the print setting screen illustrated in FIG. 11A, settings for compression that is not supported by the cloud printer driver 311 are not displayed. As seen from FIGS. 10A and 10B and FIGS. 11A and 11B, the functions of the standard printer drivers (cloud printer driver 311 and local printer driver 313) is able to be extended by the print setting extension application 312.

The print setting extension application 312 provides the user with a function for changing print settings. In a case where the settings are changed, the print setting extension application 312 stores setting values of the changed settings. For example, in a case where the user has changed the media size from “A4” to “Letter” on the print setting screen, print setting information (e.g., PrintTicket (PT)) held in the print setting extension application 312 is change from “A4” to “Letter”. When the user completes the print setting operation and presses an OK button 1002 illustrated in FIG. 10A, in step S712, the print setting screen illustrated FIG. 10A is closed.

In step S713, the print setting extension application 312 acquires the print setting information processed under the control of the print setting screen, and stores the print setting information in a storage area of the print setting extension application 312.

In step S714, the OS 310 receives a print instruction from the user via the document generation application 315, and executes printing.

In response to receipt of the print execution instruction, the OS 310 generates intermediate data. In step S715, the OS 310 transmits the generated intermediate data and the print setting information edited on the print setting screen unit to the print setting extension application 312. The intermediate data corresponds to data that is generated before conversion into print data such as page-description language (PDL). For example, the intermediate data corresponds to XML paper specification (XPS) data. The print setting information edited in the above-described step is also included in the intermediate data.

In step S716, the print setting extension application 312 checks the selected contents on the compression item for the print setting information received from the OS 310.

In a case where the print setting extension application 312 determines that the selection result on the compression item indicates “high compression” in step S716, in step S717, the print setting extension application 312 checks the compression method supported by the printer based on the capability information about the printer.

Examples of the compression method supported by the printer include the printer vendor-specific compression method such as “slim compression”. The compression method to be supported varies depending on the type of each printer. In a case where the printer supports a plurality of compression methods, the print setting extension application 312 selects a compression method with highest compression efficiency (with a smallest data size, with a smallest information loss, etc.).

The print setting extension application 312 generates print data based on the intermediate data received from the OS 310. In step S718, the print setting extension application 312 compresses the print data by the compression method selected in step S717.

In step S719, the print setting extension application 312 creates print capability information in which the print setting information received from the OS 310 is described as attribute values defined in the IPP. The description of attribute values defined in the IPP enables the cloud print-compatible printer 104 to read the information.

In this processing, for example, a compressed file format is set as an attribute document-format (mimeMediaType) indicating a file format in the print capability information, and a value indicating the applied compression method is set as a compression attribute.

In step S720, the print setting extension application 312 transmits the generated compressed print data and print capability information to the print queue for the OS 310. Specifically, the print setting extension application 312 transmits the compressed print data and print capability information to the OS 310 using an API capable of adding IPP attributes.

In step S721, the OS 310 checks a compression state of print data or checks whether to compress print data, based on the print capability information received from the print setting extension application 312. In the case of the determination of whether to compress print data, for example, the OS 310 checks the document-format. In a case where a compressed file format, such as “application/vnd.ms-cab-compressed” is set as “document-format”, the OS 310 determines that the print data has been compressed.

In a case where the OS 310 determines that the print data has been compressed, in step S722, the OS 310 skips the compression operation and transmits the compressed print data and print capability information to the print queue for the cloud print service 321.

In step S723, the cloud print service 321 transmits the compressed print data and print capability information to the cloud print-compatible printer 104 via the print queue.

A case where the print setting extension application 312 checks the selection result on the compression item in step S716 and determines that “standard compression” is selected will now be described.

In step S724, the print setting extension application 312 creates print capability information in which print setting information is described as attribute values defined in the IPP, without generating or compressing print data. For example, a file format “application/oxps” for intermediate data is set as an attribute document-format (mimeMediaType) indicating a file format in the print capability information. Then, a value (e.g., gzip) for the standard compression method supported by the printer is set as a compression attribute “compression”.

The compression method to be set for the attribute “compression” may be selected based on the compression efficiency, like in the case of selecting “high compression” as described above.

In step S725, the print setting extension application 312 transmits print capability information and intermediate data to the print queue for the OS 310. Specifically, the print setting extension application 312 transmits print capability information and intermediate data to the OS 310 using an API capable of adding IPP attributes.

In step S726, the OS 310 checks the compression state of print data described in the received print capability information. The OS 310 checks the file format and the compression attribute value in the print capability information updated in step S725, and determines whether to compress print data. In a case where the OS 310 determines that “application/oxps” is set as document-format (mimeMediaType) and a value other than “none” is set for “compression”, the OS 310 determines that there is a need to compress print data.

In step S727, in a case where the OS 310 determines that compression of print data is to be performed, the OS 310 generates print data and compresses the print data by the compression method that is supported by the cloud print-compatible printer 104 and is described in the print capability information “compression”.

Then, the OS 310 updates the value of the file format document-format (mimeMediaType) in the print capability information with the compressed file format. In a case where the OS 310 compresses print data using “gzip” as the compression method, “application/gzip” is set as the file format.

In step S728, the compressed print data and print capability information are transmitted to the print queue for the cloud print service 321 via the print queue.

In step S729, the cloud print service 321 transmits the compressed print data and print capability information to the cloud print-compatible printer 104 via the print queue.

A case where the print setting extension application 312 checks the selection result on the compression item in step S716 and determines that no setting value is designated (blank is selected) will be described.

In step S730, the print setting extension application 312 creates print capability information in which print setting information is described as attribute values defined in the IPP, without generating or compressing print data. For example, “application/pdf” or “image/pwg-raster” is set as the attribute document-format (mimeMediaType) indicating a file format in the print capability information. As the compression attribute “compression”, “none” is set.

In step S731, the print setting extension application 312 transmits print capability information and intermediate data to the print queue for the OS 310. Specifically, the print setting extension application 312 transmits print capability information and intermediate data to the OS 310 using an API capable of adding IPP attributes.

In step S732, the OS 310 checks the compression state or the like of print data described in the received print capability information.

The OS 310 checks whether “none” is set as the compression attribute “compression and “application/pdf” or “image/pwg-raster” is set as the file format document-format (mimeMediaType). After checking, in step S733, the OS 310 generates print data and compresses the print data in a PDF or Raster format.

In step S734, the OS 310 transmits the compressed print data and print capability information to the cloud print service 321.

In step S735, the cloud print service 321 transmits the print data and print capability information to the cloud print-compatible printer 104.

As described above, in response to receipt of print data and print capability information, in step S736, the cloud print-compatible printer 104 decompresses (expands) the compressed data by an appropriate method based on the print capability information, and executes printing.

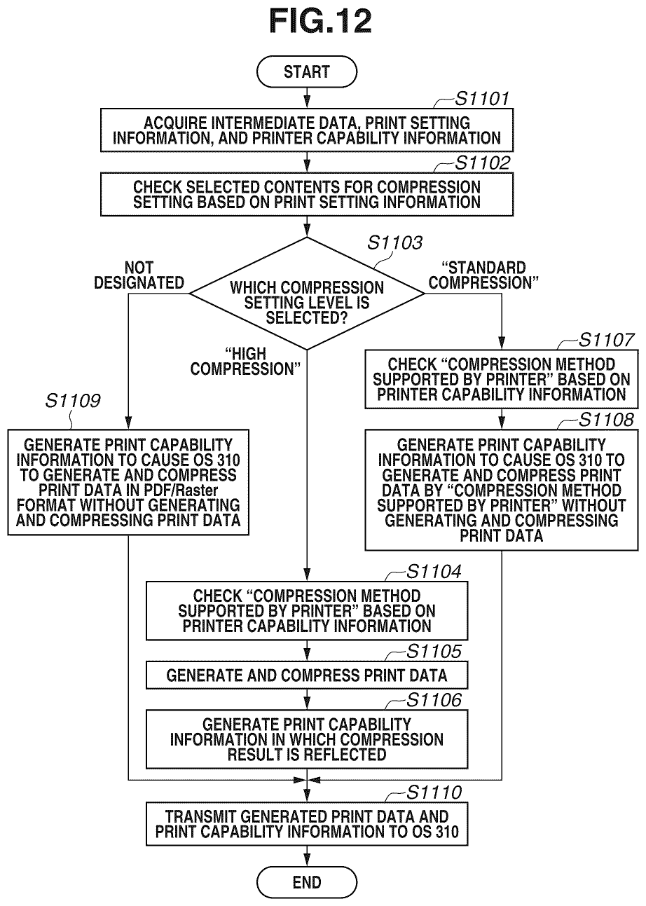

A compression determination processing procedure that is be performed by the print setting extension application 312 will be described below with reference to FIG. 12. The processing procedure illustrated in FIG. 12 is started in response to the document generation application 315 issuing a print execution instruction (in step S714 illustrated in FIG. 8A). Each process in the flowchart illustrated in FIG. 12 is implemented such that the CPU 212 executes a program provided by the print setting extension application 312.

In step S1101, the print setting extension application 312 acquires intermediate data, print setting information, and printer capability information from the OS 310 (an example of an acquisition process).

In step S1102, the print setting extension application 312 checks the selected contents on the compression setting from the acquired print setting information. In step S1103, the subsequent processing is branched depending on the selected compression setting level.

In a case where “high compression” is selected as the compression setting, the processing proceeds to step S1104. In step S1104, the print setting extension application 312 checks the compression method supported by the printer, based on the printer capability information. In a case where the printer supports a plurality of compression methods, as described above, a compression method with highest compression efficiency is selected (an example of a selection process).

In the present exemplary embodiment, “high compression” is a compression method specific to a printer vendor. Thus, in step S1105, the print setting extension application 312 generates print data and compresses the print data.

The print setting extension application 312 creates print capability information in which the print setting information received from the OS 310 is described as attribute values defined in the IPP.

For example, the print setting extension application 312 sets a compressed file format as the attribute document-format (mimeMediaType) indicating a file format in the print capability information. In step S1106, the print setting extension application 312 sets a value indicating the applied compression method as the attribute “compression” in the print capability information. This enables the OS 310 to determine that the print data has been compressed. Steps S1105 and S1106 are examples of a first generation process.

In step S1110, the print setting extension application 312 transmits the generated compressed print data and print capability information to the print queue for the OS 310 (an example of a first output process).

In step S1103, in a case where “standard compression” is selected as the compression setting, the processing proceeds to step S1107. In step S1107, the print setting extension application 312 checks the compression method supported by the printer, based on the printer capability information. In a case where the printer supports a plurality of compression methods, as described above, a compression method with highest compression efficiency is selected (an example of the selection process).

Since the standard compression is able to be performed by the OS 310, generation and compression of print data is not performed in the print setting extension application 312.

In step S1108, the print setting extension application 312 creates print capability information in which the print setting information is described as attribute values defined in the IPP (an example of a second generation process). For example, “application/oxps” indicating a file format for intermediate data is set as the attribute document-format (mimeMediaType) indicating a file format in the print capability information. Then, a value (e.g., gzip) for the standard compression method supported by the printer is set as the compression attribute “compression”. This enables the OS 310 to determine to perform generation and compression of print data and to determine the compression method to be employed.

In step S1110, the print setting extension application 312 transmits print capability information and intermediate data to the print queue for the OS 310 (an example of a second output process).

In a case where a compression setting is not designated (“NOT DESIGNATED” in step S1103), the processing proceeds to step S1109. In step S1109, the print setting extension application 312 creates print capability information in which print setting information is described as attribute values defined in the IPP, without generating or compressing print data.

For example, the print setting extension application 312 sets “application/pdf” or “image/pwg-raster” as the attribute document-format (mimeMediaType) indicating a file format in the print capability information. Further, the print setting extension application 312 sets “none” as the compression attribute “compression”. This enables the OS 310 to determine to perform generation and compression of print data in a PDF or Raster format.

In step S1110, the print setting extension application 312 transmits print capability information and intermediate data to the print queue for the OS 310.

The sequence described in the present exemplary embodiment is similar to the sequence for the printer 106. Each software acquires capability information from the printer 106 and transmits print data, for example, without involving the cloud print service 321.

In the present exemplary embodiment, “high compression” and “standard compression” are classified based on whether the compression is performed by the print setting extension application 312 or is performed by the OS 310. However, as described above, these compression methods may be classified based on the magnitude of the difference between a data size before compression and a data size after compression. In a case where a compression method specific to a printer vendor and a standard compression method, and the like are included as options, the compression method specific to the printer vendor may be selected.

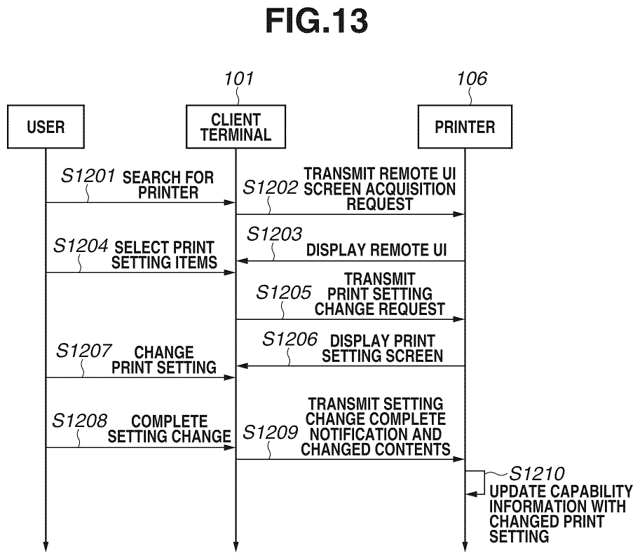

In a second exemplary embodiment, an example where an administrator controls compression will be described with reference to FIG. 13.

In step S1201, the administrator inputs an Internet Protocol (IP) address of the printer 106 to a browser of the client terminal 101, and transmits a search instruction to the client terminal 101. While the second exemplary embodiment describes a method for accessing the printer 106 using an IP address, the printer 106 may be accessed by any other method. For example, the administrator may access the printer 106 from a display unit of the printer 106 through an operation unit.

The client terminal 101 accesses the input IP address. In step S1202, the client terminal 101 transmits a request for acquiring a remote UI screen to the input IP address.

In step S1203, the printer 106 transmits the remote UI screen in response to the request from the client terminal 101, and causes the browser of the client terminal 101 to display the remote UI screen. In this processing, the remote UI screen displayed on the client terminal 101 is a screen via which a user ID and a password are input.

The administrator inputs the user ID and the password to the screen displayed on the client terminal 101 and issues a login instruction. The client terminal 101 transmits a notification about the input user ID and password to the printer 106, and the printer 106 performs user authentication processing. In a case where the user authentication processing is successful, the printer 106 transmits a setting screen to the client terminal 101.

After login, in step S1204, the administrator selects items relating to print settings on the remote UI screen.

In step S1205, the client terminal 101 transmits a print setting change request to the printer 106.

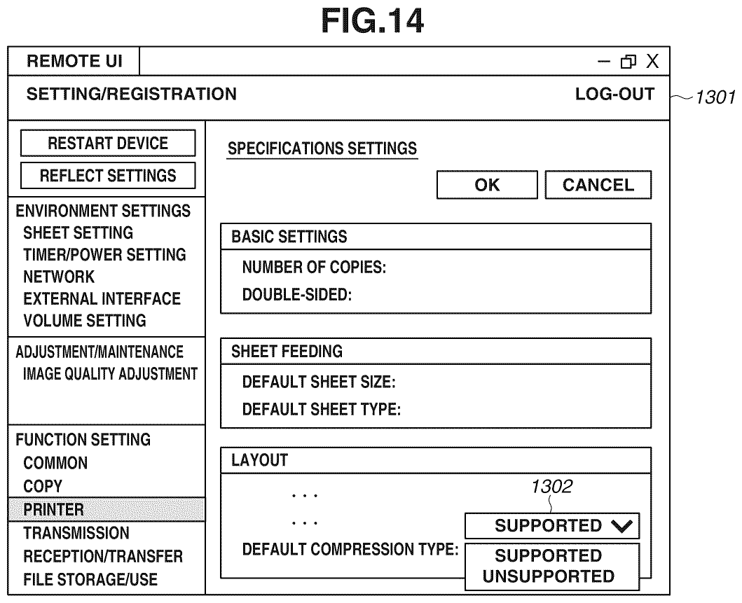

In response to receipt of the request, in step S1206, the printer 106 displays a print setting screen associated with printer capability information, for example, as a print setting form 1301 illustrated in FIG. 14.

In step S1207, the administrator changes “enable” and “disable” of the print setting in the print setting form to reflect the changed print setting in the printer capability information, whereby limitations on the setting contents are imposed. For example, in a case where the administrator disables compression on a setting UI 1302 on the setting form, i.e., “unsupported” is selected, the printer 106 does not support the compression. A value such as “none” or “unsupported”, which indicates that the printer 106 does not support the compression, is set on the “compression-supported” item relating to the compression in the IPP attributes.

In step S1208, the administrator presses an OK button to complete the setting change operation. In step S1209, the client terminal 101 transmits information indicating that the setting change operation is completed and the changed contents to the printer 106. In step S1210, the printer 106 updates the capability information based on the contents of the received print settings. Thus, the capability information about the printer 106 can be edited by the administrator.

In a case where the capability information is acquired in this state, like in steps S702 and S706 according to the first exemplary embodiment, the OS 310 and the print setting extension application 312 acquire the capability information in a state where the compression is limited.

After the above-described processing, in a case where the advanced settings screen is called in step S711, the compression item 1001 is hidden or grayed out, whereby the user cannot select the compression item 1001.

In this case, the limitation on compression may be put on a compression-related setting value basis, and some of the setting values on the compression item 1001 may be limited in accordance with constraints in the capability information, whereby the user cannot select the some of the setting values.

In the processing of step S717 and subsequent steps, printing can be performed while the compression processing is controlled in the print setting extension application 312 or the OS 310, like in the first exemplary embodiment.

Also, for the cloud print-compatible printer 104, whether to use compression or whether to use setting values for compression may be set from the printer by a method similar to that described above.

An application according to an aspect of the embodiments enables a user to select whether to compress print data and select a compression method to be employed in accordance with an intended use.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-192966, filed Nov. 13, 2023, which is hereby incorporated by reference herein in its entirety.

What is claimed is:

1. A non-transitory computer-readable storage medium storing an application program which causes a processing apparatus to perform a method, the processing apparatus having printing software, the method comprising:
acquiring capability information about a forming apparatus to which print data is to be output; and
displaying a setting screen on which setting values for setting items included in the capability information are changeable,
wherein the setting items include setting items relating to compression of print data to be output to the forming apparatus to which the print data is to be output.

2. The non-transitory computer-readable storage medium according to claim 1 further comprising:
receiving user selection of a compression method based on setting values for the setting items relating to compression designated on the setting screen,
generating, in a case where a compression method specific to a vendor of the forming apparatus to which the print data is to be output is selected, print data compressed by the selected compression method and print capability information indicating that the print data has been compressed, and
outputting the compressed print data and the print capability information to the printing software.

3. The non-transitory computer-readable storage medium according to claim 1, further comprising:
receiving user selection of a compression method based on setting values for the setting items relating to the compression designated on the setting screen,
generating, in a case where a compression method executable by the printing software is selected, print capability information including selected contents, and
outputting the print capability information to the printing software.

4. The non-transitory computer-readable storage medium according to claim 1,
wherein the capability information includes information corresponding to a plurality of compression methods, and
wherein setting values for the setting items relating to the compression are displayed on the setting screen by classifying the plurality of compression methods based on a magnitude of a difference between a data size before the compression and a data size after the compression.

5. The non-transitory computer-readable storage medium according to claim 2,
wherein the capability information includes information corresponding to a plurality of compression methods, and
wherein the processing apparatus is caused to select a compression method specific to the vendor of the forming apparatus from among the plurality of compression methods.

6. The non-transitory computer-readable storage medium according to claim 2,
wherein the capability information includes information corresponding to a plurality of compression methods, and
wherein the processing apparatus is caused to select a compression method with a largest difference between a data size before the compression and a data size after the compression from among the plurality of compression methods.

7. The non-transitory computer-readable storage medium according to claim 1, wherein the capability information is acquired from the forming apparatus to which the print data is to be output.

8. The non-transitory computer-readable storage medium according to claim 1,
wherein the print data is transmitted from the computer to the forming apparatus via a print server, and
wherein the capability information acquired from the print server.

9. The non-transitory computer-readable storage medium according to claim 2, wherein the print capability information is information in which print setting information including information about a setting value designated on the setting screen is described as an attribute value defined in Internet Printing Protocol (IPP).

10. The non-transitory computer-readable storage medium according to claim 9, wherein the print setting information is Print Ticket (PT).

11. The non-transitory computer-readable storage medium according to claim 1, wherein the capability information is editable by an administrator of the forming apparatus to which the print data is to be output.

12. A method of a processing apparatus, the processing apparatus having printing software, the method comprising:
acquiring capability information about a forming apparatus to which print data is to be output; and
displaying a setting screen on which setting values for setting items included in the capability information are changeable,
wherein the setting items include setting items relating to compression of print data to be output to the forming apparatus to which the print data is to be output.

13. The method according to claim 12, further comprising:
selecting a compression method based on setting values for the setting items relating to compression designated on the setting screen, and
performing, in a case where a compression method specific to a vendor of the forming apparatus to which the print data is to be output is selected, first generating to generate print data compressed by the selected compression method and print capability information indicating that the print data has been compressed, and first outputting to output the compressed print data and the print capability information to the printing software.

14. The method according to claim 12, further comprising:
selecting a compression method based on setting values for the setting items relating to the compression designated on the setting screen, and
performing, in a case where a compression method executable by the printing software is selected in the selecting, a second generating to generate print capability information including selected contents and second outputting to output the print capability information to the printing software.

15. The method according to claim 12,
wherein the capability information includes information corresponding to a plurality of compression methods, and
wherein setting values for the setting items relating to the compression are displayed on the setting screen by classifying the plurality of compression methods based on a magnitude of a difference between a data size before the compression and a data size after the compression.

16. The method according to claim 13,
wherein the capability information includes information corresponding to a plurality of compression methods, and
wherein a compression method specific to the vendor of the forming apparatus is selected from among the plurality of compression methods.

17. The method according to claim 13,
wherein the capability information includes information corresponding to a plurality of compression methods, and
wherein a compression method with a largest difference between a data size before the compression and a data size after the compression is selected from among the plurality of compression methods.

18. The method according to claim 12, wherein the capability information is acquired from the forming apparatus to which the print data is to be output.

19. The method according to claim 12,
wherein the print data is transmitted from the processing apparatus to the forming apparatus via a print server, and
wherein the capability information is acquired from the print server.

20. The method according to claim 13, wherein the print capability information is information in which print setting information including information about a setting value designated on the setting screen is described as an attribute value defined in Internet Printing Protocol (IPP).

21. The method according to claim 20, wherein the print setting information is Print Ticket (PT).

22. The method according to claim 12, wherein the capability information is editable by an administrator of the forming apparatus to which the print data is to be output.

23. A processing apparatus that has printing software and application program, the application program supporting the printing software, the processing apparatus comprising at least one processor operating to:
acquiring capability information about a forming apparatus to which print data is to be output; and
displaying a setting screen on which setting values for setting items included in the capability information are changeable,
wherein the setting items include setting items relating to compression of print data to be output to the forming apparatus to which the print data is to be output.
